(19) United States
(12) Patent Application Publication
(10) Pub. No.: US 2011/0213712 A1
(43) Pub. Date: Sep. 1, 2011

(54) Cloud Broker and Procurement System and Method

(75) Inventors: Ethan Hadar, Nesher (IL); Gregory Lewis Bodine, Cary, NC (US); Balakrishna Venkatrao, Westborough, MA (US)

(73) Assignee: Computer Associates Think, Ink., Islandia, NY (US)

(21) Appl. No.: 12/713,557

(22) Filed: Feb. 26, 2010

(51) Int. Cl. G06Q 10/00; G06F 15/16; G06Q 30/00

(52) U.S. Cl. 705/80; 709/226; 705/34

(57) ABSTRACT

A cloud broker and procurement system and method is closed. In particular embodiments, the method includes receiving an offer of a computing resource from each of a plurality of providers. The method further includes receiving, from each of the plurality of providers, a service level agreement associated with each respective offered computing resource. Additionally, the method includes normalizing each of the service level agreements associated with the offered computing resources. The method further includes receiving a request from a requesting computer for a computing resource and selecting, based at least in part on the normalized service level agreements, one of the providers to provide the requested computing resource. The method also includes transmitting a service match indicator to the client, wherein the service match indicator indicates a time at which the offered computing resource will be utilized, and utilizing the computing resource on the selected provider.

### TECHNICAL FIELD OF THE INVENTION

This disclosure relates generally to information technology commerce, and more particularly to a cloud broker and procurement system and method.

### BACKGROUND OF THE INVENTION

In the cloud computing domain, and specifically in the infrastructure as a service or utility computing, organizations can offload Information Technology capabilities from the organization datacenter to the public cloud. Information Technology agility increases when this on-demand service model enables organizations to quickly provision or reduce Information Technology resources according to business demands. This enables the organization to build a more cost-effective, more focused architecture that can quickly react to changing business conditions by using both internal and external resources.

In terms of the supply of computing resources, there are more resources available across the organization, located in business units computing centers, or even on employees' desktops, which currently do not participate in the overall computing power optimization, and thus, do not contribute their part in reducing capital and operational expenses.

On the demand side, requests for resources are managed by the organization for all the Information Technology resources consumers. These requests can be categories by Service Level Agreements that the service procurer is responsible to deliver and liable to the internal consumers, balancing all their needs including security, physical location, network latency, scalability, legal, compliance and more.

Thus, it is the responsibility of the organization to maximize resource utilization, attracting and retaining as many consumers as possible, while lowering overhead, and maintaining adequate service levels.

### SUMMARY OF THE INVENTION

In accordance with the present invention, the disadvantages and problems associated with cloud broker and procurement systems and methods have been substantially reduced or eliminated.

In accordance with one embodiment of the present disclosure, a method includes receiving an offer of a computing resource from each of a plurality of providers and receiving, from each of the plurality of providers, a service level agreement associated with each respective offered computing resource. The method further includes normalizing each of the service level agreements associated with the offered computing resources. Additionally, the method includes receiving a request from a requesting computer for a computing resource and selecting, based at least in part on the normalized service level agreements, one of the providers to provide the requested computing resource. The method also includes transmitting a service match indicator to the client, wherein the service match indicator indicates a time at which the offered computing resource will be utilized, and utilizing the computing resource on the selected provider.

In accordance with another embodiment of the present disclosure, a system includes a plurality of providers, wherein each of the providers is operable to transmit an offer of a computing resource associated with a respective provider. The system also includes an optimizer operable to receive, from each of the plurality of providers, a service level agreement associated with each respective offered computing resource. The optimizer is further operable to normalize each of the service level agreements associated with the offered computing resources. The optimizer is further operable to select, based at least in part on the normalized service level agreements, one of the plurality of providers to provide the requested computing resource and transmit a service match indicator to the client, wherein the service match indicator indicates a time at which the offered computing resource will be utilized. The system also includes a client operable to transmit a request for a computing resource and utilize the computing resource on the selected provider.

In accordance with yet another embodiment of the present disclosure, a computer readable medium is encoded with logic, the logic operable to, when executed on a processor to receive, from each of a plurality of providers, an offer of a computing resource. The logic is further operable to receive, from each of the plurality of providers, a service level agreement associated with each respective offered computing resource. Additionally, the logic is operable to normalize each of the service level agreements associated with the offered computing resources. The logic is further operable to select, based at least in part on the normalized service level agreements, one of the plurality of providers to provide the requested computing resource. The logic is also operable to, to facilitate utilization of the computing resource on the selected provider by the client, transmit a service match indicator to the client, wherein the service match indicator indicates a time at which the offered computing resource will be utilized.

Technical advantages of certain aspects of the present disclosure include fully utilizing all the possible utility computing resources across an enterprise that are not provided by the Information Technology Datacenter. Particular embodiments also support the selection of utility computing according the enterprises internal definition of static and well-defined Service Level Agreements, and when established, can map to a standard in the domain. Since certain embodiments of the present disclosure can fully utilize existing internal resources, it enables enterprises to increase the Return on Investment for computing resource owners, post investment, and reduce the Total Cost of Ownership overall. Moreover, the system allows enterprises to form an agile information technology infrastructure that facilitates changes, enabling the enterprise to adapt an enterprise Information Technology architecture to available resources. Particular embodiments allow an enterprise to consolidate all demand needs, and offer alternative mechanisms for those needs, thus supporting change management and projects management for less costly alternatives. Additionally, particular embodiments allow enterprises to define repeating changes in Information Technology infrastructure (according to policy and workflow automation), and enabling auctions between providers and consumers. Particular embodiments of the present disclosure may allow enterprises to accumulate needs from many consumers, and aggregate them into a single larger request, thus enabling enterprises to reduce costs paid to external (public) cloud owners. Particular embodiments may also load balance the demand and supply of computing resources by offering to change the time slot required to rent the “on-demand” service. Additionally, enterprises may change the internal pricing model (to consumers) based on peak patterns, and off-peak. Particular embodiments may also proactively suggest locations, and conduct portability between providers based on consuming patterns across the globe, considering energy issues such as using daylight for areas that utilize solar energy, or to areas that use wind power during winter.

Other technical advantages of the present disclosure will be readily apparent to one skilled in the art from the following figures, description, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description taken in conjunction with the accompanying drawings, in which:

FIG. 1 illustrates a system in accordance with particular embodiments of the present disclosure, including clients, providers, an optimizer, and a network;

FIG. 2 illustrates the optimizer illustrated in FIG. 1 in more detail, including aspects of the present disclosure; and

FIG. 3 is a flow chart illustrating a particular operation of the system of FIG. 1 in accordance with particular embodiments of the present disclosure.

### DETAILED DESCRIPTION OF THE INVENTION

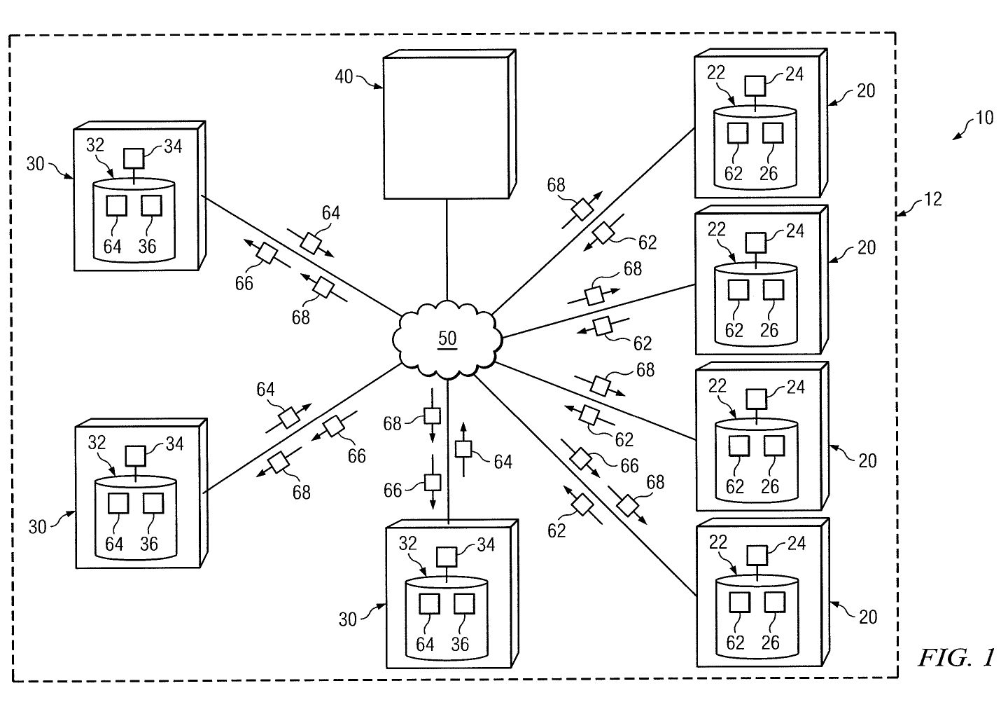

FIG. 1 illustrates a cloud broker and procurement system 10, according to certain embodiments. System 10 includes one or more clients 20, one or more providers 30, and optimizer 40. Clients 20, providers 30, and optimizer 40 may be communicatively coupled by network 50. Clients 20 and provider 30 may be located within enterprise 12. System 10 is generally operable to facilitate transactions for computing resources between clients 20 and providers 30 within enterprise 12. To facilitate transactions, optimizer 40 receives request data 62 that indicates a request for computing resources from clients 20 and offer data 64 that indicates computing resources offered by providers 30. Using information included in received request data 62 and received offer data 64, optimizer 40 selects one or more providers 30 to provide the computing resource to the requesting client 20. Thus, system 10 allows clients 20 to optimally access and utilize computing resources within enterprise 12 in addition to or alternatively to utilizing computing resources external to enterprise 12.

For purposes of this description, a computing resource refers to any service or resource associated with information technology, including, but not limited to, computer memory, computing processing power, computer storage, computer applications, computer software, computer hardware, or any other processing, storage, or exchange of electronic data. In particular embodiments, system 10 enables clients 20 to utilize computing resources provided by providers 30. For example, in particular embodiments, a computing resource represents a database that stores electronic or computer data. In this example computing resource, providers 30 may offer storage space in the database to one or more clients 20. Utilizing this example computing resource may include storing data of various types and sizes in the database. As another example, computing resource may represent a software application operating over a network. In this example computing resource, providers 30 offer to execute a software application over a computer network, and may sell access to the software application for limited or unlimited amounts of time to clients 20. Utilizing this example computing resource may include executing the software application provided by provider 30. As another example, computing resource represents a service allowing for access to processing power of provider 30 over a computer network. In this example computing resource, providers 30 allow for execution of applications on processors associated with providers 30 over a computer network. In this example, utilizing the computing resource may include installing virtual machine software on provider 30, which executes software provided by clients 20. Clients 20 may thus obtain processing time on one or more processors associated with providers 30, during which clients 20 execute software applications on a virtual machine executing on one or more providers 30.

Using request data 62 received from clients 20 and offer data 64 received from providers 30, optimizer 40 initiates transactions between clients 20 and providers 30. Optimizer 40 may initiate transactions between clients 20 and providers 30 in several ways. In one embodiment, optimizer 40 matches client 20 that requests a particular computing resource with provider 30 that offers the particular computing resource. Optimizer 40 initiates the transaction by transmitting a service match indicator to client 20 and provider 30. A service match indicator notifies client 20 that provider 30 is offering the requested computing resource, and by notifying provider 30 that client 20 is requesting the offered computing resource, and thus, a match for requested and offered computing resources is found. Clients 20 and provider 30 may transmit an acknowledgement to optimizer 40 and/or to the respective other party.

In particular embodiments, optimizer 40 may receive offer data 64 in one or more ways. Optimizer 40 may receive offer data 64 from providers 30 in response to user input, or in response to discovery requests initiated by optimizer 40. For example, optimizer 40 may scan an internal network of enterprise 12 for available computing resources. Providers 30 respond to a discovery request with offer data 64, which includes information on the types and amounts of computing resources available on a particular provider 30. In some embodiments, a user may input an interface of optimizer 30 the particular types and amounts of computing resources available at provider 30.

Once offer data 64 is received, optimizer 40 may store offer data 64 in memory 42. In particular embodiments, offer data 64 includes a Service Level Agreement (“SLA”) associated with the offered computing resource. A Service Level Agreement may indicate one or more particular times that the computing resource will be available, the cost to utilize the computing resource, performance metrics that provider 30 will guarantee to a client 20, and/or any other relevant information that may facilitate a transaction between provider 30 and client 20. For example, provider 30 may transmit offer data 64 that includes a SLA that indicates the offered computing resource is available from 6:00 p.m. to 7:00 a.m. on weekdays, and from 7 a.m. to 11:59 p.m. on weekends. The SLA may also indicate the cost to utilize the computing resource is five (5) cents per minute. The SLA may also indicate that the offered computing resource (e.g., a CPU executing a software application), will be achieve 99.9% uptime and process data at a rate of 5 gigabytes per hour. In some embodiments, provider 30 transmits a SLA associated with an offered computing resource separately from offer data 64.

In some embodiments, optimizer 40 negotiates alternative SLA terms based, at least in part, on request data 62 and/or the overall configuration of system 10. For example, enterprise 12 may establish computing resource utilization optimization policies that facilitate the full utilization of internal computing resources (i.e., resources provided by providers 30) before utilizing computing resources provided by external, third-party suppliers. In such cases, optimizer 40 may receive offer data 64 that includes particular SLA terms and request data 62 that indicates a request for a computing resource with particular SLA terms. For example, offer data 64 may include an SLA that indicates that a computing resource provided by provider 30 is available from 7:00 p.m. to 10 p.m. for 5 cents per Megabyte of data processed. Optimizer 40 may receive request data 62 from client 20 that includes a SLA requesting a computing resource from 4-6 p.m. for 3 cents per Megabyte of data processed. At this point in the negotiation, a match between request and offer is not available. However, the computing resource may be available from an external third party provider at a time and price that satisfies the requesting client 20's SLA. However, in order to maximize internal resources, optimizer 40 may transmit counter-offer 66 to the requesting client 20. Counter-offer 66 notifies client 20 that a computing resource is available from provider 30 from 7:00 p.m. to 10 p.m. for 5 cents per Megabyte of data processed. In particular embodiments, client 20 may be required to utilize the computing resource as specified in counter-offer 66. In some embodiments, client 20 may opt to utilize the third party computing resource instead. Optimizer 40 may receive and store multiple offer data 64 from one or more providers 30. Optimizer 40 may store offer data 64, and correlate stored offer data 64 with associated providers 30 offering computing resources. In some embodiments, optimizer 40 maintains a catalog of providers 30, offered computing resources and/or associated SLAs. Optimizer 40 may normalize the various SLAs associated with offered computing resources and stored in the catalog. For example, an SLA from a first provider 30 may specify the cost of a computing resource in U.S. Dollars, and an SLA from a second provider 30 may specify the cost of a computing resource in British Pounds. To normalize the SLAs, optimizer 40 may perform currency conversion to alter the specified unit of currency in one of the SLAs. As another example, an SLA from a first provider 30 specifies that an offered computing resource may process 10 Megabytes of data per second, and an SLA from a second provider 30 specifies that an offered computing resource may process 100 Gigabytes per hour. To normalize the SLAs, optimizer 40 may convert one or both of the SLAs into a standardized bytes per unit of time metric. Normalizing SLAs enables optimizer 40 to create standardized SLAs so that uniform searching, comparisons, and negotiations across multiple providers 30 and/or multiple offered computing resources are possible.

In particular embodiments, optimizer 40 may facilitate payments and charge-backs between clients 20 and providers 30. For example, a particular provider 30 may be located in a first department of enterprise 12. A client 20 may be located in a second department within enterprise 12. Additionally, for purposes of this example, provider 30 is located within the Sales Department of enterprise 12 and client 20 is located within the Accounting Department. Provider 30 is offering a computing resource (such as, e.g., storage space) to clients 20 within enterprise 12. A particular client 20 requests storage space from optimizer 40. Optimizer 40 negotiates the transaction, client 20 utilizes the computing resource, and at an appropriate time, optimizer 40 may generate a bill payable to the Sales Department and/or provider 30, and transmit it to the Accounting Department and/or client 20. In particular embodiments in which a computing resource is provided by an external, third party service provider, optimizer 40 may generate a bill payable to the third-party service provider, and transmit it to client 20.

To facilitate payments and charge-backs, optimizer 40 may monitor the utilization of computing resources provided by providers 30. In particular embodiments, optimizer 40 may monitor the use of computing resources. For example, the relevant SLA may specify the cost to use the offered computing resource on a per use, per time, per transaction, per byte, and/or per bandwidth measurement. Optimizer 40 may monitor and track the amount of computing resource utilized, as measured by any appropriate metric, to generate a bill for the particular computing resource utilized.

Clients 20 transmit request data 62 for a computing resource to optimizer 40. Request data 62 may indicate, for example, a type of requested computing resource, and a requested Service Level Agreement. A Service Level Agreement, may indicate a price client 20 is offering to pay, a time to utilize the requested computing resource, and a time at which the request expires. However, it should be understood that request data 62 may include any appropriate information suitable to request a computing resource from optimizer 40 and/or provider 30 and utilize one or more computing resources on provider 30. Client 20 also receives confirmation from optimizer 40 that a particular provider 30 is providing the requested computing resource. Once a computing resource is procured from provider 30, client 20 may interact with or more other components associated with provider 30 to utilize the requested computing resource. In particular embodiments, client 20 represents one or more components that separately request and/or utilize a computing resource provided by provider 30.

Memory 22 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 22 as internal to client 20, it should be understood that memory 22 may be internal or external to client 20, depending on particular implementations. Memory 22 may be separate from or integral to other memory devices to achieve any suitable arrangement of memory devices for use in system 10.

Memory 22 stores request data 62, one or more computing resources offered by providers 30, an amount paid for each of the computing resources, an amount of computing resources utilized by client 20, and/or any other information associated with the request, procurement, reception, and/or utilization of computing resources. Memory 22 also stores logic 26. Logic 26 generally comprises rules, algorithms, code, tables, and/or other suitable instructions for storing and/or generating request data 62 and responding to offer data 64.

Memory 22 is communicatively coupled to processor 24. Processor 24 is generally operable to execute logic 26 to perform the functionality provided by clients 20. Processor 24 comprises any suitable combination of hardware and software implemented in one or more modules to provide the described function or operation.

Providers 30 provide computing resources to clients 20. Providers 30 use optimizer 40 to facilitate the utilization of computing resources with one or more clients 20. For example, provider 30 may transmit offer data 64 to optimizer 40 that indicates a computing resource offered by provider 30. Provider 30 may transmit a Service Level Agreement to optimizer 40 that indicates a price provider is offering to accept, a time during which provider 30 is offering the computing resource, and a time at which the offer expires. In some embodiments, optimizer 40 may transmit to provider 30 counter-offer 66, which may request a computing resource offered by provider 30, but with one or more terms of the Service Level Agreement altered. Provider 30 may provide one or more computing resources. For example, provider 30 may provide internet website hosting, data storage, internet application hosting, software as a service hosting, virtual machine hosting, and/or application processing. It should be understood, however, that provider 30 may provide any computing resource associated with the processing, transfer, generating and/or exchange of data.

In particular embodiments, provider 30 represents a computer that is capable of interacting with optimizer 40 to offer computing resources to one or more clients 20 and capable of providing the computing resource to clients 20. In other embodiments, provider 30 represents one or more computers that collectively perform the described functions. For example, a particular component of provider 30 interacts with optimizer 40 to offer computing resources to clients 20, and a separate component of provider 30 communicates and/or interacts with clients 20 to provide the computing resource to clients 20.

In some embodiments, provider 30 may be located external to enterprise 12 and/or owned, managed, and/or controlled by a third-party service provider. In such embodiments, optimizer 40 receive offer data 64 from the third-party provider 30. Client 20 may utilize computing resources provided by the third-party provider 30. Moreover, optimizer 40 may dynamically change the selected provider 30 during the utilization of the computing resource. For example, client 20 may be utilizing a computing resource on a first provider 30 located within enterprise 12. At one point during execution, optimizer 40 receives offer data 64 and/or locates information within its catalog indicating that a lower cost third-party provider 30 is available for computing resource utilization. At an appropriate transition point (such as, for example, between jobs in a batch processing job), optimizer 40 may transition the utilization of the computing resource to the third-party provider 30. Likewise, optimizer 40 may transition, during the utilization of a computing resource, the computing resource utilization from a third-party provider 30 to a provider 30 located within enterprise 12.

Provider 30 comprises memory 32 and processor 34. Memory 32 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 32 as internal to provider 30, it should be understood that memory 32 may be internal or external to provider 30, depending on particular implementations. Memory 32 may be separate from or integral to other memory devices to achieve any suitable arrangement of memory devices for use in system 10.

Memory 32 stores offer data 64, Service Level Agreements associated with computing resources offered by a particular provider 30, a list of clients 20 receiving computing resources from provider 30, an amount paid for each of the computing resources, and/or any other information associated with the offer, procurement, provisioning, and/or utilization of computing resources. Memory 32 also stores logic 36. Logic 36 generally comprises rules, algorithms, code, tables, and/or other suitable instructions for offering and/or providing computing resources.

Memory 32 is communicatively coupled to processor 34. Processor 34 is generally operable to execute logic 36 to perform the functionality provided by provider 30. Processor 34 comprises any suitable combination of hardware and software implemented in one or more modules to provide the described function or operation.

Operator 40 facilitates the utilization of computing resources within enterprise 12 by matching clients 20 with providers 30. Optimizer 40 receives request data 62 from clients 20 and receives offer data 64 from providers 30. In particular embodiments, optimizer 40 may match willing providers and users of computing resources. In some embodiments, optimizer 40 may monitor the utilization of a computing resource on a particular provider 30 to determine the amount of computing resources utilized. Using the amount of computing resources utilized, operator 40 may facilitate payments and charge-backs between clients 20 and providers 30. Additionally, depending on the policies and configuration implemented in system 10, optimizer 40 may transmit counter-offer 66 to client 20 in response to request data 62. Counter-offer 66 may include information indicating an alternative Service Level Agreement for the provisioning of computing resources by client 20.

Each of client 20, provider 30, and optimizer 40 comprises any suitable combination of hardware and/or software implemented in one or more modules to provide the described functions and operations. In some embodiments, client 20, provider 30, and/or optimizer 40 may comprise a general-purpose personal computer (PC), a Macintosh, a workstation, a Unix-based computer, a server computer, or any suitable processing device. In some embodiments, the functions and operations described above may be performed by a pool of multiple clients 20, providers 30, and/or optimizers 40.

Clients 20, providers 30, and optimizer 40 are communicatively coupled via one or more networks 50. Network 50 may represent any number and combination of wireline and/or wireless networks suitable for data transmission. Network 50 may, for example, communicate interne protocol packets, frame relay frames, asynchronous transfer mode cells, and/or other suitable information between network addresses. Network 50 may include one or more intranets, local area networks, metropolitan area networks, wide area networks, cellular networks, all or a portion of the Internet, and/or any other communication system or systems at one or more locations.

In operation, optimizer 40 receives request data 62 from clients 20 and offer data 64 from providers 30, and facilitates the utilization of computing resources within enterprise 12. Optimizer 40 receives request data 62 from clients 20. Request data 62 includes a request for computing resource. For example, request data 62 may include a request for data storage, access to software as a service operated by provider 30, access to internet-based applications hosted by provider 30, access to computing time on a processor operated by provider 30, internet website hosting, access to a virtual machine hosted on provider 30, and/or any other appropriate information technology service associated with the processing, transfer, generating and/or exchange of data. In some embodiments, optimizer 40 receives request data 62 over network 50. Additionally, optimizer 40 may receive a plurality of request data 62 from a particular client 20 and/or a plurality of clients 20.

Optimizer receives offer data 64 from provider 30, which indicates that provider 30 is offering computing resources in accordance with a Service Level Agreement. As noted above, an offer for a computing resource may include an offer for data storage, access to software as a service operated by provider 30, access to internet-based applications hosted by provider 30, access to computing time on a processor operated by provider 30, internet website hosting, applications executing on a virtual machine hosted by provider 30, and/or any other appropriate information technology service or device associated with the processing, transfer, generating and/or exchange of data. Optimizer 40 may receive offer data 64 information technology service from provider 30 over network 50.

At appropriate points during operation, optimizer 40 may normalize SLAs received from providers 30. Normalizing SLAs may ensure uniform cataloging, searching, comparison, and provisioning of computing resources. To normalize the SLAs, optimizer 40 may convert SLAs received from providers 30 and/or clients 20 into a standardized metric. Normalizing SLAs enables optimizer 40 to create standardized SLAs to allow for uniform searching, comparisons, and negotiations across multiple providers 30 and/or multiple offered computing resources.

Once request data 62 and offer data 64 is received, optimizer 40 may facilitate transactions between client 20 requesting a particular computing resource and providers 30 providing the requested computing resource. Optimizer 40 selects a particular provider 30 to provide the computing resource to a particular client 20. Optimizer 40 selects provider 30 to provide the information technology service based on any appropriate criteria, factors, or variables. In particular embodiments, optimizer 40 may compare the requested SLA to one or more stored SLAs associated with computing resources on providers 30. Based on the comparison, optimizer 40 selects a provider 30 that is offering a computing resource having a SLA that matches the SLA requested by client 20. For example, request data 62 may include an SLA indicating that client 20 is offering to pay $1 per Gigabyte of storage per month. Optimizer 40 may select a particular provider 30 that is offering the lowest price for data storage that is equal to or less than $1 per Gigabyte per month. As another example, request data 62 may include an SLA that indicates client 20 is requesting immediate execution of an application. Optimizer 40 may select a particular provider 30 that is offering the soonest execution time. In general, however, optimizer 40 may select provider 30 based on a combination of any appropriate criteria, factors, or variables.

Once provider 30 is selected to provided the requested computing resource, optimizer 40 initiates a transaction between client 20 and provider 30. Optimizer 40 may initiate a transaction by transmitting a service match indicator 68 to provider 30 and client 20. Service match indicator 68 may indicate that client 20 is requesting a computing resource acceptable to provider 30, and that provider 30 is offering a computing resource that is acceptable to client 20. In particular embodiments, client 20 and provider 30 may transmit to optimizer 40 an acknowledgement that client 20 and/or provider 30 accept the transaction. The receipt of acknowledgement may finalize the transaction.

After or during the utilization of the computing resource offered by provider 30, optimizer 40 may facilitate payments and charge-backs between clients 20 and providers 30 for the utilization of computing resources on providers 30. For example, a particular provider 30 may be located in a first department of enterprise 12. A client 20 may be located in a second department within enterprise 12. Optimizer 40 may monitor and generate a bill to client 20 in the second department for the utilization of computing resources in the first department. Optimizer may transmit a bill to client 20, a budgeting officer within the department, a supervisor within the department, and/or any other relevant entity or person. In particular embodiments in which a computing resource is provided by an external, third party service provider, optimizer 40 may generate a bill payable to the third-party service provider, and transmit it to client 20. Additionally, optimizer 40 may accept payment for the requested information technology service from client 20, or client 20 may pay the relevant provider 30 directly.

By enabling clients 20 to optimally utilize computing resources within enterprise 12, and providing for inter-departmental payments and charge-backs, system 10 provides numerous operational benefits. For example, particular embodiments of system 10 enable the full utilization of all the possible computing resources across an enterprise that are not provided by an Information Technology Datacenter. Particular embodiments also support the selection of utility computing according an internal definition of static and well-defined Service Level Agreements, and when established, can map to a standard in the domain. Since certain embodiments of system 10 can fully utilize existing internal resources, it enables enterprises to increase the Return on Investment for computing resource owners, post investment, and reduce the Total Cost of Ownership overall. Moreover, system 10 allows enterprises to form an agile information technology infrastructure that facilitates changes, enabling the enterprise to adapt an enterprise Information Technology architecture to available resources. Particular embodiments of system 10 allow an enterprise to consolidate all demand needs, and offer alternative mechanisms for those needs, thus supporting change management and projects management for less costly alternatives. Additionally, particular embodiments allow enterprises to define repeating changes in Information Technology infrastructure (according to policy and workflow automation), and enabling auctions between providers and consumers. Particular embodiments of the present disclosure may allow enterprises to accumulate needs from many consumers, and aggregate them into a single larger request, thus enabling enterprises to reduce costs paid to external (public) cloud owners. Particular embodiments of system 10 may also load balance the demand and supply of computing resources by offering to change the time slot required to rent the “on-demand” service. Additionally, enterprises may change the internal pricing model (to consumers) based on peak patterns, and off-peak. Particular embodiments may also proactively suggest locations, and conduct portability between providers based on consuming patterns across the globe, considering energy issues such as using daylight for areas that utilize solar energy, or to areas that use wind power during winter.

As a result, system 10 may provide numerous operational benefits. Nonetheless, particular embodiments may provide some, none, or all of these operational benefits, and may provide additional operational benefits.

Modifications, additions, or omissions may be made to system 10 without departing from the scope of the invention. For example, in the illustrated embodiment, clients 20, provider 30, and optimizer 40 are represented as different components of system 10. However, the functions of client 20, provider 30 and optimizer 40 may be performed by any suitable combination of one or more servers or other components at one or more locations. In the embodiment where the various components are servers, the servers may be public or private servers, and each server may be a virtual or physical server. The server may include one or more servers at the same or at remote locations. Also, clients 20, provider 30, and optimizer 40 may include any suitable component that functions as a server. Additionally, system 10 may include any number of clients 20, providers 30, and/or optimizers 40. Any suitable logic may perform the functions of system 10 and the components within system 10.

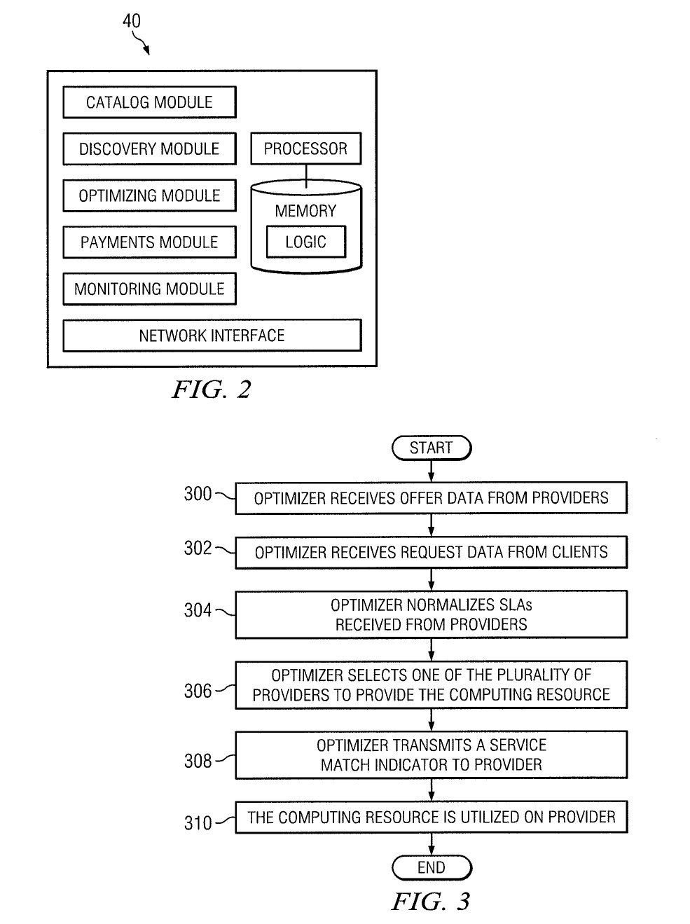

FIG. 2 is a block diagram illustrating aspects of the optimizer 40 discussed above with respect to FIG. 1. As discussed above, optimizer 40 enables clients 20 to utilize computing resources on providers 30 by negotiating transactions between the respective clients 20 and providers 30. Optimizer 40 includes catalog module 202, discovery module 204, optimizing module 206, payments module 208, monitoring module 210, memory 212, processor 216, and network interface 218.

Catalog module 202 receives offer data 64 from providers 30, and stores information associated with offered computing resources. In particular embodiments, offer data 64 includes one or more Service Level Agreements associated with a computing resource of a particular provider 30. Catalog module receives the Service Level Agreements, and may store the SLAs in memory 212 for subsequent searching, ordering, and retrieving. Additionally, catalog module 202 may be operable to normalize SLAs received from providers 30. Catalog module 202 may transfer the different SLAs defined by the public cloud vendors, or accumulated by the assortments of providers 30 into a static, single-format SAL so optimization and unified search capabilities can be applied. Normalizing SLAs may ensure uniform cataloging, searching, comparison, and provisioning of computing resources. To normalize the SLAs, catalog module 202 may convert SLAs received from providers 30 and/or clients 20 into a standardized metric. Normalizing SLAs enables optimizer 40 to create standardized SLAs to allow for uniform searching, comparisons, and negotiations across multiple providers 30 and/or multiple offered computing resources. In general, catalog module 202 maintains all the possible computing resources available for “rent,” as well as those that are currently provisioned, and their relative expiration date of the rental period.

Discovery module 204 discovers computing resources offered by providers 30 within enterprise 12. In particular embodiments, discovery module 204 may discover computing resources available within enterprise 12 in several ways. Discovery module 204 may receive offer data 64 from providers 30 in response to user input, or in response to discovery requests initiated by discovery module 204. For example, discovery module 204 may scan an internal network of enterprise 12. Providers 30 respond to a discovery request with offer data 64, which includes information on the types and amounts of computing resources available on a particular provider 30, and a Service Level Agreement associated with the offered computing resource. In some embodiments, a user may input into an interface of optimizer 40 and/or other relevant component of system 10 the particular types and amounts of computing resources available at provider 30. Additionally, based on integration into one or more discovery engines, discovery module 204 can offer or suggest to providers 30 to contribute their computing power when not in use by a user of provider 30. When a particular provider 30 is registered by discovery module 204, it may be transformed to run a virtualization environment such as, for example, VMWare. In such a case, the particular provider 30's own server image will be maintained, and additional images will be mounted as needed. When a particular provider 30 is allocated and prepared as a candidate computing resource, its information is transferred to catalog module 202 for processing.

Optimizing module 206 receives request data 62 from clients 20 and offer data 64 from providers 30. As discussed above, request data 62 may indicate a request for a type and amount of a computing resource. Additionally, request data 62 may include a Service Level Agreement that client 20 desires for the requested computing resource. In particular embodiments, optimizing module 206 compares the requested type of computing resource, amount of computing resource, and/or Service Level Agreement associated with of the requested computing resource to offered computing resources stored in memory 212. Based on the comparison, optimizing module 206 finds the best match between providers 30 and clients 20. Optimizing module 206 may then select a provider 30 to provide the requested computing resource, and transmit to the selected provider 30 and client 20 service match indicator 68, indicating a match between the offered computing resource and the requested computing resource. Provider 30 and client 20 may each transmit to optimizing module 206 and acknowledgement of the completed transaction. In some embodiments, optimizing module 206 may transmit counter-offer 66 to client 20 and/or provider 30 in response to receiving request data 62 and/or offer data 64. Counter-offer 66 may include information indicating an alternative Service Level Agreement, an alternative time at which to utilize computing resources, and/or alternative amount for the utilization of computing resources by client 20. Client 20 and/or provider 30 may accept or reject the counter-offer 66 by transmitting an appropriate message to optimizing module 206. In general, optimizing module 206 conducts negotiations, forecasts demands (such as, for example, queued request data 62), and matches available computing resources from providers 30 to possible clients 20. It may offer providers 30 an option to rent their machines at previously unscheduled times in order to comply with demand from clients 20, and may suggest to prospective clients 20 to change their consumption needs based on cheaper rates, or improved SLAs. Optimizing module 206 optimizes and caters to clients 20 and providers 30 where the goal is to lower the price of the usage or other SLA parameters and not necessarily to maximize the benefits of the providers 30 only. The optimization reflects the overall needs of enterprise 12 to reduce costs, and enable improved capacity planning. Additionally, optimizing module 206 may offer to clients 20 and/or providers 30 to alter their SLA requirements, in order to accommodate different SLA resources available in the catalog maintained by catalog module 202.

Payments module 208 monitors the utilization of computing resources and generates a bill payable to provider 30 that provides the computing resource. After client 20 utilizes a computing resource on a particular provider 30, payments module 208 may generate a bill payable to a department and/or provider 30 within enterprise 12 that provided the computing resource, and payable by a department and/or client 20 within enterprise 12 that utilized the computing resource. In particular embodiments in which a computing resource is provided by an external, third party service provider, payments module 208 may generate a bill payable to the third-party service provider, and transmit it to client 20. In particular embodiments, monitoring module 208 represents an internal “accounts payable” system, that finalizes the procurement and utilization of computing resources. In particular embodiments, payments module 208 is coupled to the overall utilizing of a provider 30, and accumulates all the pricing models applied to the pricing component. It means that the brokering service can accumulate payments from clients 20 (machine users), and pay differently to providers 30 (machine owners), in order to balance payments to internal providers 30 and/or external public cloud vendors.

Monitoring module 210 may monitor the utilization of computing resources provided by providers 30, and provide information on utilization to payments module 208 to facilitate payments and charge-backs. In particular embodiments, monitoring module 210 may monitor the use of computing resources. For example, the relevant SLA may specify the cost to use the offered computing resource on a per use, per time, per transaction, per byte, and/or per bandwidth measurement. Monitoring module 208 may monitor and track the amount of computing resource utilized, as measured by any appropriate metric, to generate an appropriate bill for the particular computing resource utilized. Whether the method of accounting is pay-per-use, by time, by byte, or by I/O measurement, the method of charging is internal and abstract the actual payments to the providers 30, thus acting as a full financial brokering service.

Memory 212 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 2 illustrates memory 212 as internal to optimizer 40, it should be understood that memory 212 may be internal or external to optimizer 40, depending on particular implementations. Memory 212 may be separate from or integral to other memory devices to achieve any suitable arrangement of memory devices for use in system 10.

Memory 212 is generally operable to store request data 62, offer data 64, and any other appropriate information associated with the procurement and utilization of computing resources in enterprise 12. Memory 24 is further operable to store logic 214.

Processor 216 is generally operable to execute logic 214 to receive request data 62 from clients 20 and offer data 64 from providers 30. Processor 216 facilitates transactions between clients 20 and providers 30 by determining whether an offered computing resource and associated SLA included in offer data 64 matches a request for a computing resource included in request data 62. In particular embodiments, processor 216 may execute logic 214 to negotiate transactions between and match clients 20 and providers 30. Processor 216 comprises any suitable combination of hardware and software implemented in one or more modules to provide the described function or operation.

Network interface 218 communicates information relevant to the procurement and utilization of computing resources between client 20 and provider 30 over network 50. For example, network interface 218 receives request data 62 from client 20 through network 50. Similarly, network interface 218 receives offer data 64 from provider 30 through network 50. Additionally, network interface 218 may transmit counter-offer 66 to client 20 and/or provider 30. Network interface 218 represents any port or connection, real or virtual, including any suitable hardware and/or software that allows optimizer 40 to exchange information with network 50, client 20, provider 30, and/or or other components of system 10.

In general, each of catalog module 202, discovery module 204, optimizing module 206, payments module 208, monitoring module 210, memory 212, processor 216, and network interface 218 represent any appropriate combination of hardware and/or software suitable to perform the described functions. Additionally, any two or more of catalog module 202, discovery module 204, optimizing module 206, payments module 208, monitoring module 210, memory 212, processor 216, and network interface 218 may include common elements.

FIG. 3 is a flow diagram illustrating an operation in accordance with a particular embodiment of system 10. It should be understood that the flow diagram illustrated in FIG. 3 represents one example of an operation that may be performed in a particular embodiment of system 10. System 10 may perform other operations in accordance with particular embodiments as described in the present disclosure.

Operation, in the illustrated example, begins at step 300 with optimizer 40 receiving offer data 64 from providers 30. Optimizer 40 receives offer data 64 from provider 30, which indicates an offered computing resource. Additionally, offer data 64 may include a Service Level Agreement that specifies terms under which provider 30 is offering a computing resource. For example a SLA may indicate a price, times at which a computing resource is available, and service level guarantees. As noted above, an offer for a computing resource may include an offer for data storage, access to software as a service operated by provider 30, access to internet-based applications hosted by provider 30, access to computing time on a processor operated by provider 30, interne website hosting, applications executing on a virtual machine hosted by provider 30, and/or any other appropriate information technology service or device associated with the processing, transfer, generating and/or exchange of data. Optimizer 40 may receive offer data 64 information technology service from provider 30 over network 50.

At step 302, optimizer 40 receives request data 62 from clients 20. Request data 62 includes a request for computing resource. Additionally, request data 62 may include a requested SLA under which indicates terms under which client 20 is willing to procure computing resources from provider 30. An SLA included in request data 62 may indicate a price at which client 20 is willing to purchase computing resources, times at which client 20 desires to utilize computing resources, and service level guarantees. Request data 62 may include a request for data storage, access to software as a service operated by provider 30, access to internet-based applications hosted by provider 30, access to computing time on a processor operated by provider 30, interne website hosting, access to a virtual machine hosted on provider 30, and/or any other appropriate information technology service associated with the processing, transfer, generating and/or exchange of data. In some embodiments, optimizer 40 receives request data 62 over network 50. Additionally, optimizer 40 may receive a plurality of request data 62 from a particular client 20 and/or a plurality of clients 20.

At step 304, optimizer 40 normalizes SLAs received from providers 30 and/or clients 20. Normalizing SLAs may ensure uniform cataloging, searching, comparison, and provisioning of computing resources. To normalize the SLAs, optimizer 40 may convert SLAs received from providers 30 and/or clients 20 into a standardized metric. Normalizing SLAs enables optimizer 40 to create standardized SLAs to allow for uniform searching, comparisons, and negotiations across multiple providers 30 and/or multiple offered computing resources.

At step 306 optimizer 40 selects one of the plurality of providers 30 to provide the computing resource to a particular client 20. Optimizer 40 selects provider 30 to provide the computing resource based on any appropriate criteria, factors, or variables. In particular embodiments, optimizer 40 may compare the requested SLA to one or more stored SLAs associated with computing resources on providers 30. Based on the comparison, optimizer 40 selects a provider 30 that is offering a computing resource having a SLA that matches the SLA requested by client 20. For example, request data 62 may include an SLA indicating that client 20 is offering to pay $1 per Gigabyte of storage per month. Optimizer 40 may select a particular provider 30 that is offering the lowest price for data storage that is equal to or less than $1 per Gigabyte per month. As another example, request data 62 may include an SLA that indicates client 20 is requesting immediate execution of an application. Optimizer 40 may select a particular provider 30 that is offering the soonest execution time. In general, however, optimizer 40 may select provider 30 based on a combination of any appropriate criteria, factors, or variables.

At step 308, optimizer 40 initiates a transaction between client 20 and provider 30. Optimizer 40 may initiate a transaction by transmitting a service match indicator 68 to provider 30 and/or client 20. Service match indicator 68 may indicate that client 20 is requesting a computing resource acceptable to provider 30, and that provider 30 is offering a computing resource that is acceptable to client 20. In particular embodiments, service match indicator 68 may represent request data 62 and/or offer data 64. In particular embodiments, client 20 and provider 30 may transmit to optimizer 40 an acknowledgement that client 20 and/or provider 30 accept the transaction. The receipt of acknowledgement may finalize the transaction.

At step 310, client 20 utilizes the offered computing resource on provider 30. In particular embodiments, optimizer 40 may install virtual machine software on provider 30 to execute software provided by client 20. Provider 30's own server image may be maintained, and additional images will be mounted as needed by optimizer 40. In some embodiments, client 20 may utilize data storage, memory, processing power, a hosted software application, and/or any other computing resource on provider 30. In particular embodiments, optimizer 40 may dynamically change the selected provider 30 during the utilization of the computing resource. For example, client 20 may be utilizing a computing resource on a first provider 30 located within enterprise 12. At one point during execution, optimizer 40 receives offer data 64 and/or locates information within its catalog indicating that a lower cost second provider 30 is available for computing resource utilization. At an appropriate transition point (such as, for example, between jobs in a batch processing job), optimizer 40 may transition the utilization of the computing resource to the second provider 30.

The steps illustrated in FIG. 3 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method comprising:
receiving an offer of a computing resource from each of a plurality of providers;
receiving, from each of the plurality of providers, a service level agreement associated with each respective offered computing resource;
normalizing each of the service level agreements associated with the offered computing resources;
receiving a request from a requesting computer for a computing resource;
selecting, based at least in part on the normalized service level agreements, one of the providers to provide the requested computing resource;
transmitting a service match indicator to the client, wherein the service match indicator indicates a time at which the offered computing resource will be utilized; and
utilizing the computing resource on the selected provider.

2. The method of claim 1, wherein the selected provider is associated with a first department within an enterprise, and wherein the requesting computer is associated with a second department within the enterprise, and further comprising generating a bill to the second department that is payable to the first department.

3. The method of claim 1, wherein selecting one of the providers comprises:
comparing the normalized service level agreements associated with the offered computer resources to the request for a computing resource;
based on the comparison, selecting a service level agreement associated with an offered computing resource; and
selecting the provider associated with the selected service level agreement.

4. The method of claim 1, wherein the request indicates:
a first time for utilizing the requested computing resource; and
a first price for utilizing the requested computing resource; and wherein selecting a provider to provide the computing resource comprises:
based on the first time and the first price, transmitting a counter-offer for the requested computing resource to the requesting computer, wherein the counter-offer indicates a second time for utilizing the computing resource and a second price for utilizing the computing resource; and
receiving, from the requesting computer, an acceptance of the counter-offer; and wherein utilizing the computing resource on the selected provider comprises utilizing the computing resource at the second time.

5. The method of claim 1, wherein the offer indicates:
a first time for utilizing the offered computing resource; and
a first price for utilizing the computing resource;
wherein selecting a provider to utilize the offered computing resource comprises:
based on the first time and the first price, transmitting a request for a computing resource to a provider, wherein the request indicates a second time for utilizing the computing resource and a second price for utilizing the computing resource; and
receiving, from the provider, an acceptance of the request; and
wherein utilizing the computing resource on the selected provider comprises utilizing the computing resource at the second time.

6. The method of claim 1, wherein each of the service level agreements indicates an amount of computing resources available, a price at which the computer resources are offered, and a time at which the computer resources are available.

7. A system comprising:
a plurality of providers, wherein each of the providers is operable to:
transmit an offer of a computing resource associated with a respective provider;
an optimizer operable to:
receive, from each of the plurality of providers, a service level agreement associated with each respective offered computing resource;
normalize each of the service level agreements associated with the offered computing resources;
select, based at least in part on the normalized service level agreements, one of the plurality of providers to provide the requested computing resource;
transmit a service match indicator to the client, wherein the service match indicator indicates a time at which the offered computing resource will be utilized; and
a client operable to:
transmit a request for a computing resource; and
utilize the computing resource on the selected provider.

8. The system of claim 7, wherein the selected provider is associated with a first department within an organization, and wherein the requesting computer is associated with a second department within the organization, and further comprising generating a bill to the second department that is payable to the first department.

9. The system of claim 7, wherein the optimizer is operable to select one of the providers by:
comparing the normalized service level agreements associated with the offered computer resources to the request for a computing resource;
based on the comparison, selecting a service level agreement associated with an offered computing resource; and
selecting the provider associated with the selected service level agreement.

10. The system of claim 7, wherein the request indicates:
a first time for utilizing the requested computing resource; and
a first price for utilizing the requested computing resource; and wherein the optimizer is operable to select a provider to provide the computing resource by:
based on the first time and the first price, transmitting a counter-offer for the requested computing resource to the client, wherein the counter-offer indicates a second time for utilizing the computing resource and a second price for utilizing the computing resource; and
wherein the client is operable to utilize the computing resource on the selected provider by utilizing the computing resource at the second time.

11. The system of claim 7, wherein the offer indicates:
a first time for utilizing the offered computing resource; and
a first price for utilizing the computing resource;
wherein the optimizer is operable to select a provider to utilize the offered computing resource by transmitting, based on the first time and the first price, a request for a computing resource to a provider, wherein the request indicates a second time for utilizing the computing resource and a second price for utilizing the computing resource; and
wherein the client is operable to utilize the computing resource on the selected provider by utilizing the computing resource at the second time.

12. The system of claim 7, wherein each of the service level agreements indicates an amount of computing resources available, a price at which the computer resources are offered, and a time at which the computer resources are available.

13. A computer readable storage medium encoded with logic, the logic operable, when executed on a processor, to:
receive, from each of a plurality of providers, an offer of a computing resource;
receive, from each of the plurality of providers, a service level agreement associated with each respective offered computing resource;
normalize each of the service level agreements associated with the offered computing resources;
select, based at least in part on the normalized service level agreements, one of the plurality of providers to provide the requested computing resource; and
to facilitate utilization of the computing resource on the selected provider by the client, transmit a service match indicator to the client, wherein the service match indicator indicates a time at which the offered computing resource will be utilized.

14. The computer readable storage medium of claim 13, wherein the selected provider is associated with a first department within an enterprise, and wherein the requesting computer is associated with a second department within the enterprise, and further comprising generating a bill to the second department that is payable to the first department.

15. The computer readable storage medium of claim 13, wherein the logic is operable to select one of the plurality of providers by:
comparing the normalized service level agreements associated with the offered computer resources to the request for a computing resource;
based on the comparison, selecting a service level agreement associated with an offered computing resource; and
selecting the provider associated with the selected service level agreement.

16. The computer readable storage medium of claim 13, wherein the request indicates:
a first time for utilizing the requested computing resource; and
a first price for utilizing the requested computing resource; and wherein the optimizer is operable to select a provider to provide the computing resource by:
based on the first time and the first price, transmitting a counter-offer for the requested computing resource to the client, wherein the counter-offer indicates a second time for utilizing the computing resource and a second price for utilizing the computing resource; and
wherein the logic is operable to, to facilitate utilization of the computing resource on the selected provider by the client, transmit a service match indicator to the client, wherein the time indicated by the service match indicator is the second time.

17. The computer readable storage medium of claim 13, wherein the offer indicates:
a first time for utilizing the offered computing resource; and
a first price for utilizing the computing resource;
wherein the logic is operable to select a provider to utilize the offered computing resource by transmitting, based on the first time and the first price, a request for a computing resource to a provider, wherein the request indicates a second time for utilizing the computing resource and a second price for utilizing the computing resource; and
wherein the logic is operable to, to facilitate utilization of the computing resource on the selected provider by the client, transmit a service match indicator to the client, wherein the time indicated by the service match indicator is the second time.

18. The computer readable storage medium of claim 13, wherein each of the service level agreements indicates an amount of computing resources available, a price at which the computer resources are offered, and a time at which the computer resources are available.

19. A system comprising:
means for receiving an offer of a computing resource from each of a plurality of providers;
means for receiving, from each of the plurality of providers, a service level agreement associated with each respective offered computing resource;
means for normalizing each of the service level agreements associated with the offered computing resources;
means for receiving a request from a requesting computer for a computing resource;
means for selecting, based at least in part on the normalized service level agreements, one of the providers to provide the requested computing resource;
means for transmitting a service match indicator to the client, wherein the service match indicator indicates a time at which the offered computing resource will be utilized; and
means for utilizing the computing resource on the selected provider.
